(19) United States
(12) Patent Application Publication
(10) Pub. No.: US 2013/0314045 A1
(43) Pub. Date: Nov. 28, 2013

(54) CHARGING AN ENERGY STORE

(71) Applicants: Peter Feuerstack, Ludwigsburg (DE); Erik Weissenborn, Stuttgart (DE); Martin Kessler, Schwaebisch Gmuend (DE)

(72) Inventors: Peter Feuerstack, Ludwigsburg (DE); Erik Weissenborn, Stuttgart (DE); Martin Kessler, Schwaebisch Gmuend (DE)

(73) Assignee: ROBERT BOSCH GMBH, Stuttgart (DE)

(21) Appl. No.: 13/984,289

(22) PCT Filed: Dec. 29, 2011
(86) PCT No.: PCT/EP2011/074217

§ 371 Date: Aug. 8, 2013

(30) Foreign Application Priority Data
Feb. 9, 2011 (DE) 10 2011 003 859.0

(51) Int. Cl. H02J 7/02

(52) U.S. Cl. CPC H02J 7/022
USPC 320/116

(57) ABSTRACT

The invention relates to a system for charging at least one energy storing cell (5) in a controllable energy store (2) that is used to control and supply electric energy to an n-phase electric machine (1), wherein n≧1. The controllable energy store (2) has n parallel energy supply branches (3-1, 3-2, 3-3), each of which has at least two serially connected energy storing modules (4), each said energy storing module comprising at least one electric energy storing cell (5) with a corresponding controllable coupling unit (6). The energy supply branches (3-1, 3-2, 3-3) can be connected to a reference bus (T-), and each energy supply branch can be connected to a phase (U, V, W) of the electric machine (1). The coupling units (6) bridge the respective corresponding energy storing cells (5) or connect same into the respective energy supply branch (3-1, 3-2, 3-3) dependent on control signals. The aim of the invention is to allow at least one energy storing cell (5) to be charged. This is achieved in that each energy supply branch (3-1, 3-2, 3-3) can be connected to and separated from a secondary side (9-1′; 9-1″; 9-2′; 9-2″; 9-3′; 9-3″) of a charging transformer (10′; 10-1″; 10-2″; 10-3″) by a respective controllable switching element (21-1; 21-2; 21-3), an additional charging inductor (20-1; 20-2; 20-3) being arranged in each connecting line between the energy supply branches (3-1, 3-2, 3-3) and the secondary sides (9-1′; 9-1″; 9-2′; 9-2″; 9-3′; 9-3″) of the charging transformer (10′; 10-1″; 10-2″; 10-3″).

### BACKGROUND OF THE INVENTION

The invention relates to a system for charging an energy store and to a method for operating the charging system of the invention.

The trend is that in the future electronic systems which combine new energy store technologies with electrical drive technology will be used increasingly both in stationary applications, such as wind power plants, and in vehicles, such as hybrid or electric vehicles. In conventional applications, an electrical machine which is in the form of a polyphase machine, for example, is controlled via a converter in the form of an inverter. A characteristic feature of such systems is a so-called DC voltage intermediate circuit, via which an energy store, generally a battery, is connected to the DC voltage side of the inverter. In order to be able to meet the requirements for a respective application placed on power and energy, a plurality of battery cells are connected in series. Since the current provided by such an energy store needs to flow through all of the battery cells and a battery cell can only conduct a limited current, battery cells are often additionally connected in parallel in order to increase the maximum current.

A series circuit comprising a plurality of battery cells entails the problem, in addition to a high total voltage, that the entire energy store fails when a single battery cell fails because no battery current can flow any more. Such a failure of the energy store can result in failure of the entire system. In the case of a vehicle, a failure of the drive battery can render the vehicle “unusable”. In other applications such as the rotor blade adjustment of wind power plants, for example, hazardous situations may even arise in the event of unfavorable boundary conditions, such as a strong wind, for example. Therefore, a high degree of reliability of the energy store is always desired, whereby “reliability” is intended to mean the capacity of a system to operate fault-free for a predetermined time.

In the earlier applications DE 10 2010 027857 and DE 10 2010 027861, batteries having a plurality of battery module strings have been described which can be connected directly to an electrical machine. In this case, the battery module strings have a plurality of series-connected battery modules, wherein each battery module has at least one battery cell and an associated controllable coupling unit, which makes it possible, depending on control signals, to interrupt the respective battery module string or to bypass the respectively associated at least one battery cell or to connect the respectively associated at least one battery cell into the respective battery module string. By suitably actuating the coupling units, for example with the aid of pulse-width modulation, it is also possible for suitable phase signals for controlling the electrical machine to be provided, with the result that a separate pulse-controlled inverter is not required. The pulse-controlled inverter required for controlling the electrical machine is therefore integrated in the battery, so to speak. For the purposes of the disclosure, these two earlier applications are incorporated in full in the present application.

### SUMMARY OF THE INVENTION

The present invention provides a system for charging at least one energy storage cell in a controllable energy store which is used to control and supply electrical energy to an n phase electrical machine, where n≧1. In this case, the controllable energy store has n parallel energy supply branches, which have in each case at least two energy storage modules, which are connected in series and comprise in each case at least one electrical energy storage cell having an associated controllable coupling unit. The energy storage modules can be connected on one side to a reference rail and on the other side to in each case one phase of the electrical machine. The coupling units are configured in this case as full-bridges. Depending on control signals, the coupling units bypass the respectively associated energy storage cells or they connect the respectively associated energy storage cells into the respective energy supply branch. By means of a respective controllable switching element, the energy supply branches can be connected in each case to a secondary side of a charging transformer and can be isolated therefrom. In this case, in each case additional charging inductances are arranged in the connection lines between the energy supply branches and the secondary sides of the charging transformer.

The invention also provides a method for operating a charging system of the invention, in which, in a current increase stage in the energy supply branches, a voltage which is smaller in terms of magnitude than that at the secondary side of the charging transformer is set and, in a current reduction stage following the current increase stage in the energy supply branches, a voltage which is greater in terms of magnitude than that at the secondary side of the charging transformer is set.

### ADVANTAGES OF THE INVENTION

If the energy storage cells of the controllable energy store are to be charged via a charging transformer, the AC voltage present at the secondary side (secondary winding) of a charging transformer must first be rectified. The invention is based on the basic concept of using the switching elements of the coupling units configured as a full bridge to rectify the secondary-side AC voltage of the charging transformers. For this purpose, the secondary sides of the charging transformers are connected to the energy supply branches of the controllable energy store via in each case one charging inductance. The voltage at the charging inductance results as the difference between a secondary voltage at the secondary side of the charging transformer and the voltage at the controllable energy store. The rectifier function is now realized by the energy storage cells in each case being connected into the respective energy supply branch with that polarity such that they are charged. In this case, in a current increase stage in the energy supply branches, a voltage which is smaller in terms of magnitude than that at the secondary side of the charging transformer is set, with the result that energy is supplied to the charging inductances and stored there. In a current reduction stage following the current increase stage in the energy supply branches, a voltage which is greater in terms of magnitude than that at the secondary side of the charging transformer is set, as a result of which the charging current as a whole is limited. In this case, the voltage in the energy supply branches is determined in each case by the number of energy storage cells connected into the respective energy supply branch. In this way, a constant charging current results during both stages, that is, the current increase stage and the current reduction stage.

The elimination of a separate rectifier unit on the secondary side of the charging transformer leads to savings both in terms of cost and of installation space. Some switched-mode power supply topologies, for instance a so-called “dual active bridge”, likewise require a controllable full bridge on the secondary side of a transformer. Switched-mode power supply topologies of this type can likewise be realized with the aid of the arrangement according to the invention.

In order to prevent a short circuit during the motor operating mode of the electrical machine when the secondary side of the charging transformer is connected directly to the energy supply branches via additional charging inductances, controllable switching elements, by means of which the secondary side of the charging transformer can be connected to the energy supply branches during the charging operating mode and can be disconnected from said energy supply branches during the motor operating mode of the electrical machine, are provided.

According to one embodiment of the invention, the charging transformer has n secondary windings, which can in each case be connected on one side to an energy supply branch and on the other side to the reference rail.

Alternatively, the energy supply branches can also be connected to the secondary side of a respectively associated charging transformer via the respective additional charging inductance.

In this case, the charging transformers represent unsymmetrical voltage sources, which can lead to the production of undesired torques in the electrical machine. In particular in the case of circuitry of this type, it makes sense to provide further controllable switching elements, by means of which the electrical machine can be isolated from the energy supply branches.

Alternatively or in addition, undesired moments during the charging process can also be avoided by the electrical machine being mechanically blocked during the charging process, for example using a transmission pawl. Alternatively, the rotor position of the electrical machine can also be monitored, for example using an appropriate sensor system, and can be disconnected in the event of a detected rotor movement.

The charging system of the invention is designed to be galvanically isolated and can also be designed as an inductive charging device, that is to say that all of the components from the mains inlet up until the primary winding can be located in an off-board charging device and the transformer can be appropriately modified, that is to say designed to be planar. When it is used in a vehicle, it results in the advantage that, other than the secondary winding of the charging transformer, no additional components for realizing the charging function must be carried in the vehicle.

Further features and advantages of embodiments of the invention result from the following description with reference to the attached figures.

### BRIEF DESCRIPTION OF THE DRAWINGS

FIG. 1 is a schematic illustration of a first embodiment of a charging system of the invention and

FIG. 2 is a schematic illustration of a second embodiment of a charging system of the invention.

### DETAILED DESCRIPTION

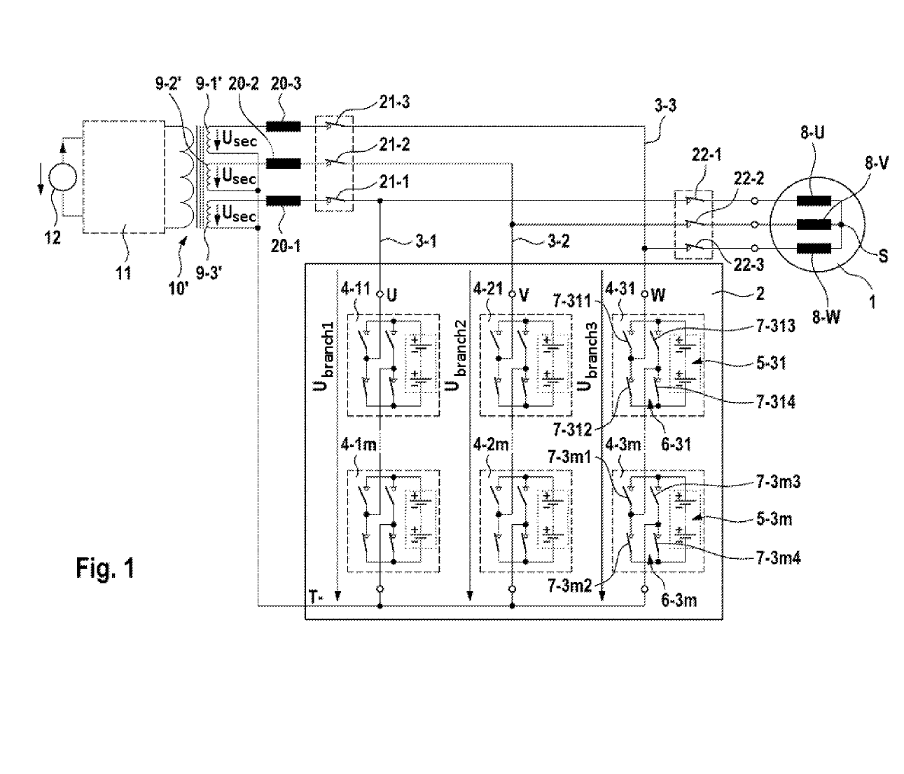

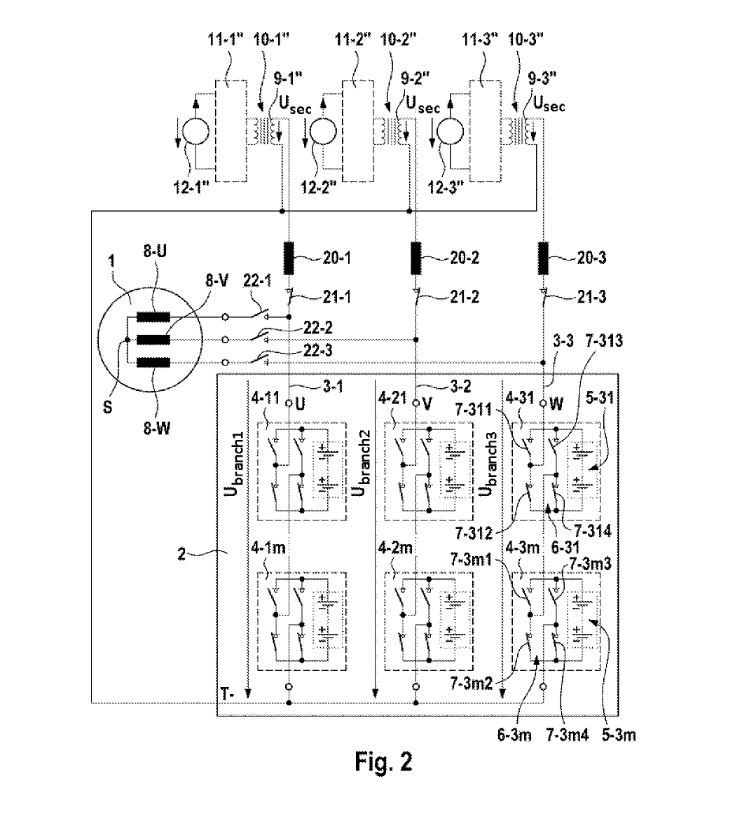

FIGS. 1 and 2 show schematic illustrations of embodiments of a charging system of the invention. A controllable energy store 2 is connected to a three-phase electrical machine 1. The controllable energy store 2 comprises three energy supply branches 3-1, 3-2 and 3-3, which are connected on one side to a reference potential T- (reference rail), which supplies a low potential in the illustrated embodiments, and on the other side in each case to individual phases U, V and W of the electrical machine 1. Each of the energy supply branches 3-1, 3-2 and 3-3 have m series-connected energy storage modules 4-11 to 4-1m or 4-21 to 4-2m or 4-31 to 4-3m, where m>2. In turn, the energy storage modules 4 comprise in each case a plurality of series-connected electrical energy storage cells, which, for reasons of clarity, are only provided with reference signs 5-31 to 5-3m in the energy supply branch 3-3 connected to the phase W of the electrical machine 1. Furthermore, the energy storage modules 4 comprise in each case one coupling unit, which is associated with the energy storage cells 5 of the respective energy storage module 4. For reasons of clarity, the coupling units are also only provided with reference signs 6-31 to 6-3m in the energy supply branch 3-3. In the illustrated variant embodiments, the coupling units 6 are in each case formed from four controllable switching elements 7-311, 7-312, 7-313 and 7-314 to 7-3m1, 7-3m2, 7-3m3 and 7-3m4, which are interconnected in the form of a full bridge. In this case, the switching elements can be designed as power semiconductor switches, for example in the form of IGBTs (insulated gate bipolar transistors) or as MOSFETs (metal oxide semiconductor field-effect transistors).

The coupling units 6 make it possible to interrupt the respective energy supply branch 3 by opening all of the switching elements 7 of a coupling unit 6. Alternatively, by closing in each case two of the switching elements 7 of a coupling unit 6, the energy storage cells 5 can either be bypassed, for example closing the switches 7-312 and 7-314, or connected into the respective energy supply branch 3, for example closing the switches 7-312 and 7-313.

The total output voltages of the energy supply branches 3-1 to 3-3 are determined by the respective switching state of the controllable switching elements 7 of the coupling units 6 and can be adjusted in steps. This stepwise adjustment results depending on the voltage of the individual energy storage modules 4. If the preferred embodiment of identically configured energy storage modules 4 is used as a basis, a maximum possible total output voltage results from the voltage of an individual energy storage module 4 times the number m of energy storage modules 4 which are connected in series per energy supply branch 3.

The coupling units 6 therefore make it possible to connect the phases U, V and W of the electrical machine 1 either to a high reference potential or to a low reference potential and to this extent can also perform the function of a known inverter. Thus, the power and mode of operation of the electrical machine 1 can be controlled by the controllable energy store 2 given suitable actuation of the coupling units 6. The controllable energy store 2 therefore performs a dual function to this extent since it is used firstly for electrical energy supply and secondly also for controlling the electrical machine 1.

The electrical machine 1 has stator windings 8-U, 8-V and 8-W, which are to one another in star in a known manner.

In the exemplary embodiments illustrated, the electrical machine 1 is in the form of a three-phase AC machine but can also have less than or more than three phases. The number of energy supply branches 3 in the controllable energy store 2 is naturally also dependent on the number of phases of the electrical machine.

In the exemplary embodiments illustrated, each energy storage module 4 has in each case a plurality of series-connected energy storage cells 5. However, the energy storage modules 4 can also alternatively each have only one single energy storage cell or else parallel-connected energy storage cells.

In the exemplary embodiments illustrated, the coupling units 6 are each formed by four controllable switching elements 7 in the form of a full bridge, which also provides the possibility of a voltage reversal at the output of the energy storage module. However, the coupling units 6 can also be realized by more or less controllable switching elements as long as the required functions (bypassing of the energy supply cells and connection of the energy supply cells into the energy supply branch) can be realized.

In order to make it possible to charge energy storage cells 5 of one or more energy storage modules 4, according to a first embodiment of the invention, illustrated in FIG. 1, a charging transformer 10′ is directly connected to the energy supply branches 3 of the controllable energy store 2 via additional charging inductances 20.

The charging transformer 10′ has three secondary windings 9-1′, 9-2′ and 9-3′ on the secondary side, which windings can be connected on one side to the energy supply branch 3-1 or 3-2 or 3-3 via in each case one of the charging inductances 20-1 or 20-2 or 20-3 and are connected on the other side to the reference rail T-. In the motor operating mode of the electrical machine 1, in order to avoid a short circuit of the energy supply branches 3 via the charging inductances 20 and the secondary windings 9′, in each case controllable switching elements 21-1, 21-2 and 21-3 are arranged in the connection lines between the secondary windings 9′ and the energy supply branches 3. These also make it possible to isolate the secondary windings 9′ and the charging inductances 20 from the energy supply branches 3.

On the primary side, a switching unit 11, for example in the form of a half or full bridge, is connected upstream of the charging transformer 10, which switching unit connects the primary side of the charging transformer 10 to an AC voltage source 12.

An AC voltage is present in each case at the secondary windings 9′ of the charging transformer 10′, which voltage must be rectified in order to be able to be used as a charging voltage for one or more energy storage cells 5 of the controllable energy store 2. Using the coupling units 6 of the controllable energy store 2, which coupling units are configured in full-bridge topology, it is now possible to realize the rectifier function without a separate rectifier unit. For this purpose, the energy storage cells 5 to be charged are connected into the respective energy supply branch 3 by means of corresponding control of the switching elements 7 of the respectively associated coupling unit 6 with the respective polarity, so that they are charged.

In order to charge the energy storage cells 5, charging inductances are also required, which are formed by the additional charging inductances 20.

A voltage U_{L} across a charging inductance 20-1, 20-2 or 20-3 appears as the difference between a secondary voltage U_{sec} on the secondary side of the charging transformer 10 and a string voltage U_{branch1} or U_{branch2} or U_{branch3} at the respectively associated energy supply branch 3-1 or 3-2 or 3-3. The charging of the energy storage cells 5 takes place in two stages.

In a current increase stage, the voltage U_{L} must be positive (U_{L}>0) in order to store charging energy in the respective charging inductance 20-1 or 20-2 or 20-3. This can be achieved by a voltage which is smaller in terms of magnitude than the secondary voltage U_{sec} being set at the respective energy supply branch 3 (|U_{branch}|<|U_{sec}|). The string voltage U_{branch} is dependent on the number of energy storage cells 5 connected in the respective energy supply branch 3 and can therefore be actively influenced by targeted connection and/or disconnection of energy storage cells 5 using the coupling units 6. In this case, the gradient of the charging current can also be controlled by the respectively set string voltage U_{branch}.

In order not to let the charging current rise indefinitely, a current reduction stage, in which the voltage U_{L} is negative (U_{L}<0), follows the current increase stage with the result that the energy stored in the respective charging inductance 20 can be emitted again. This can be achieved by a voltage which is greater in terms of magnitude than the secondary voltage U_{sec} being set at the respective energy supply branch 3 (|U_{branch}|>|U_{sec}|). Again, this voltage ratio is also set by targeted connection and/or disconnection of energy storage cells 5 using the coupling units 6.

In this way, a constant charging current results during both stages, that is, the current increase stage and the current reduction stage.

If the charging voltages U_{sec} are unsymmetrical, undesired moments can build up in the electrical machine 1. To avoid moments of this type during the charging process, further controllable switching elements 22-1, 22-2 and 22-3 can be provided, by means of which the electrical machine 1 can be isolated from the energy supply branches 3-1, 3-2 and 3-3.

Alternatively or in addition, undesired moments during the charging process can also be avoided by the electrical machine 1 being mechanically blocked during the charging process, for example using a transmission pawl. Alternatively, the rotor position of the electrical machine 1 can be monitored, for example using an appropriate sensor system, and can be disconnected in the event of a detected rotor movement.

Alternatively to a charging transformer having a plurality of secondary windings, a separate charging transformer 10-1″ or 10-2″ or 10-3″ with a respectively associated switching unit 11″ and AC voltage source 12″ can of course also be provided for each energy supply branch 3-1, 3-2 and 3-3 (FIG. 2). In this case, the connection of the secondary windings 9 1″, 9-2″ and 9-3″ to the reference rail T- is merely optional. Otherwise, this third embodiment does not differ, in terms of the construction and functionality thereof, from the first embodiment according to FIG. 1.

1. A system for charging at least one energy storage cell in a controllable energy store which is used to control and supply electrical energy to an n-phase electrical machine, where n>1, wherein
the controllable energy store has n parallel energy supply branches, which
have in each case at least two energy storage modules, which are connected in series and comprise in each case at least one electrical energy storage cell having an associated controllable coupling unit,
can be connected on one side to a reference rail and
can be connected on the other side to in each case one phase of the electrical machine,
the coupling units are configured as full bridges and, depending on control signals, bypass the respectively associated energy storage cells or connect the respectively associated energy storage cells into the respective energy supply branch,
by means of a respective controllable switching element, the energy supply branches can be connected in each case to a secondary side of a charging transformer and can be isolated therefrom, wherein in each case one additional charging inductance is arranged in the connection lines between the energy supply branches (3-1, 3-2, 3-3) and the secondary sides of the charging transformer.

2. The system as claimed in claim 1, wherein the charging transformer has n secondary windings on the secondary side, which secondary windings can in each case be connected on one side to an energy supply branch and on the other side to a reference rail.

3. The system as claimed in claim 1, wherein the energy supply branches can in each case be connected to the secondary side of a respectively associated charging transformer via the respective additional charging inductance.

4. The system as claimed in claim 2, wherein the electrical machine can be isolated from the energy supply branches by means of controllable switching elements.

5. A method for operating a charging system as claimed in claim 1, the method comprising,
in a current increase stage in the energy supply branches, setting a voltage which is smaller in terms of magnitude than that at the secondary side of the charging transformer and
in a current reduction stage following the current increase stage in the energy supply branches setting a voltage which is greater in terms of magnitude than that at the secondary side f the charging transformer.
